(19) United States
(12) Patent Application Publication
(10) Pub. No.: US 2015/0367968 A1
(43) Pub. Date: Dec. 24, 2015

(54) SYSTEMS AND METHODS FOR A MOMENTUM PLATFORM

(71) Applicant: Honeywell International Inc., Morristown, NJ (US)

(72) Inventors: Mitch Fletcher, Glendale, AZ (US); Brett McMickell, Scottsdale, AZ (US)

(21) Appl. No.: 14/309,275

(22) Filed: Jun. 19, 2014

(51) Int. Cl. B64G 4/00; G05D 1/08; B64G 1/28

(52) U.S. Cl. CPC B64G 4/00; B64G 1/286; B64G 1/283; G05D 1/0883; B64G 2001/245

(57) ABSTRACT

Systems and methods for a momentum platform are provided. For example, a system for opposing torques includes a platform, wherein the platform is transportable to different locations in a zero-gravity environment and a plurality of momentum devices within the platform, wherein the plurality of momentum devices provide controllable angular momentum. The system also includes a torque feedback device, wherein the torque feedback device detects the torques experienced by the platform; a processing unit that controls the angular momentum of the plurality of momentum devices based on the torques detected by the torque feedback device such that the platform remains stable in response to the torques; and a mounting surface on the platform for attaching objects to the platform.

### BACKGROUND

In relatively recent history, humans have begun to explore the space beyond the planet earth. In these explorations, instruments and vehicles have allowed man to experience many of the wonders of space that were unknown to previous generations. During space travel, whether it is to gather data or perform external maintenance on a vehicle, a person may have to perform tasks that involve spacewalking. As one ventures into space, to perform a spacewalk, one experiences very little gravity. The lack of gravity may pose problems when a human attempts to perform basic maintenance tasks (such as applying torque to a wrench) or data gathering activities (such as chipping rock from an asteroid). For example, during equipment maintenance, a human, when applying torque to a wrench, may spin around the wrench unless the human is anchored to a fixed position in relation to the equipment being maintained.

### SUMMARY

Systems and methods for a momentum platform are provided. For example, a system for opposing torques includes a platform, wherein the platform is transportable to different locations in a zero-gravity environment and a plurality of momentum devices within the platform, wherein the plurality of momentum devices provide controllable angular momentum. The system also includes a torque feedback device, wherein the torque feedback device detects the torques experienced by the platform; a processing unit that controls the angular momentum of the plurality of momentum devices based on the torques detected by the torque feedback device such that the platform remains stable in response to the torques; and a mounting surface on the platform for attaching objects to the platform.

### DRAWINGS

Understanding that the drawings depict only exemplary embodiments and are not therefore to be considered limiting in scope, the exemplary embodiments will be described with additional specificity and detail through the use of the accompanying drawings, in which:

FIG. 1 is a drawing illustrating an astronaut using a momentum platform in one embodiment described in the present disclosure;

FIG. 2 is a block diagram illustrating a system for controlling a momentum platform in one embodiment described in the present disclosure;

FIG. 3 is a drawing illustrating a momentum platform capable of translational motion in one embodiment described in the present disclosure; and

FIG. 4 is a flow diagram of a method 400 for controlling a momentum platform in one embodiment described in the present disclosure.

In accordance with common practice, the various described features are not drawn to scale but are drawn to emphasize specific features relevant to the exemplary embodiments.

### DETAILED DESCRIPTION

In the following detailed description, reference is made to the accompanying drawings that form a part hereof, and in which is shown by way of illustration specific illustrative embodiments. However, it is to be understood that other embodiments may be utilized and that logical, mechanical, and electrical changes may be made. Furthermore, the method presented in the drawing figures and the specification is not to be construed as limiting the order in which the individual steps may be performed. The following detailed description is, therefore, not to be taken in a limiting sense.

Embodiments described in the present application provide for a platform that inhibits rotation when exposed to external torques. For example, the platform may be mountable by an astronaut or other object in space that may experience torques where the platform contains multiple control motion gyroscopes (CMGs) or other momentum devices that adjust their angular momentum in response to the forces applied to the platform. The stored angular momentum causes the platform to provide a stable surface against which an astronaut can stand as the platform absorbs the rotational torques applied by the astronaut. To determine the torques applied to the platform, sensors, either within the platform or outside the platform can measure the torques. The measured forces are provided to a processing unit, where the processing unit determines adjustments to the momentum devices, such that the angular momentum of the momentum devices applies a torque that is substantially equal and opposite to the external torques applied to the platform.

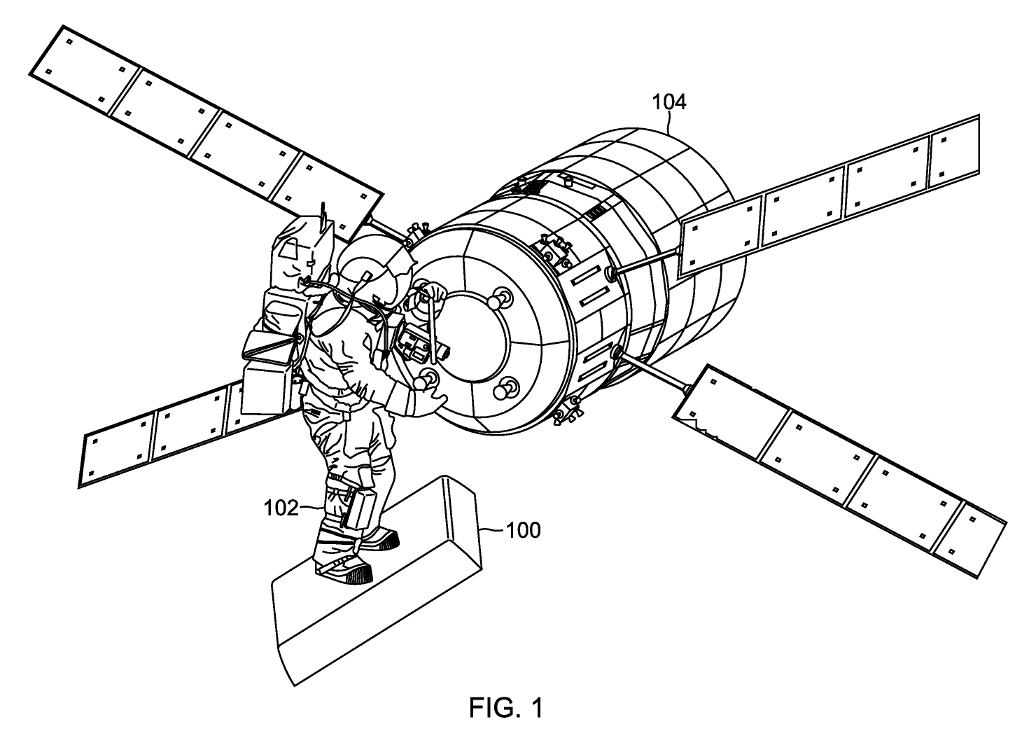

FIG. 1 provides an illustration of an astronaut 102 standing on a platform 100, where the platform 100 provides a stable base from which the astronaut may work on a space vehicle 104, where the space vehicle includes any object that travels through space. For example, space vehicle 104 includes a satellite, a space ship, a space station, an asteroid, and the like. In at least one implementation, the platform 100 may include a series of mounting fixtures that allow a person to securely mount their feet against the platform 100. When the astronaut 102 is securely attached to or braced against the platform 100, as the astronaut 102 applies forces to the space vehicle 104 that exert a torque on the astronaut 102, the momentum devices located within the platform 100 react to torques on the platform 100 such that the platform 100 and the astronaut 102 are able to remain stable while the astronaut 102 completes various tasks on the space vehicle 104.

In an alternative implementation, the platform 100 may attach to a different location on the astronaut. For example, the platform 100 may attach to the back, or another location on the astronauts body. When the platform 100 is attached to another location on the astronaut 102, the astronaut 102 is fixedly attached to the platform 100 such that the torques experienced by the astronaut 102 are also experienced by the platform 102.

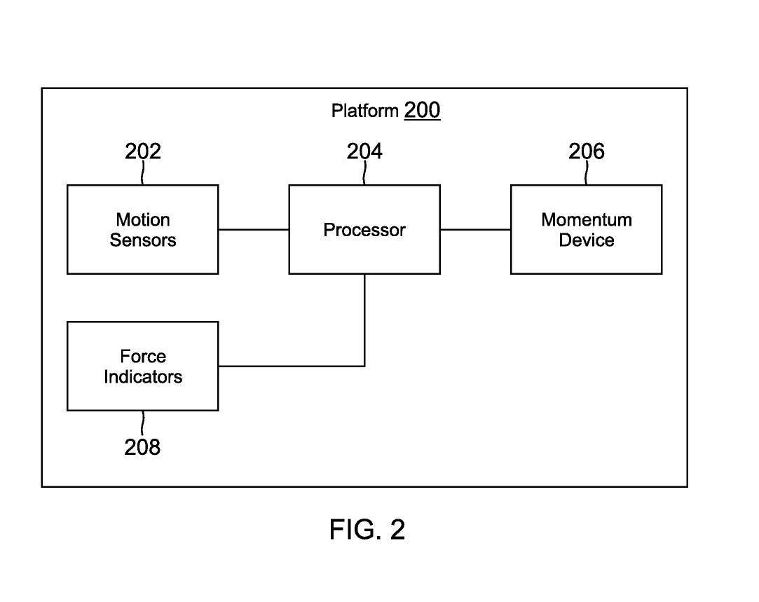

FIG. 2 is a block diagram of a system within a platform 200 for reducing the motion of the platform in response to torques. In certain implementations, the platform 200 functions similarly to platform 200 in FIG. 2. The platform 200 is an object to which a person or object is mounted when performing a task in a near zero-gravity environment. In certain embodiments, an individual or a robot may be mounted to the platform 200 when performing a maintenance task on a vehicle. For example, a human, within a space suit, may mount the boots of his spacesuit to the platform 200 before moving into space. When mounted to the platform 200, a human may maneuver the platform 200 to the location on the vehicle that is in need of maintenance. When the platform 200 is positioned, the human may then attempt to perform the desired maintenance task. Frequently, maintenance tasks may include the application of torque to an object. For example, if a nut is in need of tightening or loosening, the application of force to the nut using a wrench exerts a torque on the human and the platform 200 to which the human is mounted. In response to the external torques, components within the platform 200 complete a momentum exchange that balance the external torques exerted on the platform 200 through the use of momentum devices 206. As described below, momentum devices may be an array of control moment gyroscopes (CMGs) or an array of reaction wheels. Due to the exchange of momentum by the momentum devices 206 within the platform 200, torques exerted on the platform 200 may be cancelled out, such that a human is able to perform tasks that involve torque without experiencing undesired rotation by bracing oneself against the platform 200.

In a similar application, a human or robot may attempt to gather objects from space. For example, a person may attempt to approach an asteroid to acquire a portion of the asteroid with the intent to perform research on the piece of asteroid. When the person arrives at the asteroid, the person may attempt to chisel a piece of rock through the use of a hammer. Due to the lack of gravity, when the person swings the hammer against either a chisel in contact with the asteroid or directly against the asteroid, the force exerted by the person may exert a torque on the platform 200. Without the ability to absorb the torques, the person and the platform would rotate away from the asteroid in an opposite direction of the force applied to the asteroid. In a similar manner to the maintenance task described above, the momentum devices 206 within the platform 200 exert a force to oppose the torques on the platform 200, such that a person may continue to exert a force on the asteroid or other body without moving away from the asteroid.

As stated above, the platform 200 includes momentum devices 206. In certain embodiments, momentum devices 206 include a CMG. A CMG is an attitude control device generally used in spacecraft attitude control systems for 3-axis vehicle stabilization. A CMG generally includes a spinning rotor and one or more motorized gimbals that tilt the rotor's angular momentum. As the rotor tilts, the changing angular momentum causes a gyroscopic torque that, through the principle of conservation of momentum, results in the rotation of the spacecraft. Alternately, the change in angular momentum could absorb disturbance motion, thus stabilizing the spacecraft. In a further alternative, the momentum device could include a reaction wheel. A reaction wheel also includes a spinning rotor, but momentum is exchanged by altering the speed of the rotor.

As described above, the momentum devices 206 are controlled to counter torques that act on the platform 200. To control the movement of the momentum devices 206, the platform 200 includes a processing unit 204. When the momentum devices 206 are control moment gyroscopes, the processing unit 204 sends control signals to actuators that control the motion of the gimbals that orient the control moment gyroscopes. In another alternative embodiment, where the control moment gyroscopes are variable-speed control moment gyroscopes, the processing unit 204 is also able to send signals that control the rotational speed of the spinning rotor. In at least one embodiment, the processing unit 204 is a microcontroller, an FPGA, an analog circuit, or other type of electronic circuitry that is able to process measurements for controlling the actuators that control the momentum devices 206. In an alternative embodiment, the platform 200 includes a receiver that receives transmissions from an off-platform processing unit 204 through a transmitter. Upon receiving the transmissions, the receiver on the platform 200 acquires instructions from the transmissions that are used to control the actuators that control the momentum devices 206.

In at least one implementation, to control the orientation of the spinning rotors of the control moment gyroscopes, the processing unit 204 receives information that indicates the amount of torque that is applied to the platform 200 from torque feedback devices. For example, the platform 200 may also include a series of motion sensors 202 that function as torque feedback devices. The motion sensors 202 may include an inertial navigation system comprised of accelerometers and gyroscopes. Alternatively, other sensors other than an inertial navigation system may provide the motion information.

In one implementation, the motion sensors 202, located within platform 200, measure motion experienced by the platform. The motion sensors 202 then provide the motion measurements to the processing unit 204. When the processing unit 204 receives the motion measurements from the motion sensors 202, the processing unit 204 controls the position of the gimbals in the control moment gyroscopes, such that the angular momentum of the rotors in the control motion gyroscopes works against torques experienced by the platform 200. As the angular momentum of the spinning rotors works against external torques, the platform 200 is able to provide a stable base from which a person or other object, such as a robot, may perform tasks within a low gravity environment.

Further, in certain implementations, the platform 200 includes force indicators 208 that function as torque feedback devices. Force indicators 208 include sensors and instrumentation that provide measurements of rotational movement to the processing unit 204 by either monitoring the platform 200 or by measuring different sources that can apply a torque to the platform 200. In one exemplary implementation, force indicators 208 include a camera or vision sensor that monitors the platform 200 for movement. For example, when a person goes outside of a space vehicle to perform a maintenance task, the task may require the application of a torque to the surface of the space vehicle. In one particular example, a user may attempt to twist a bolt with a wrench. In twisting the bolt, the user applies a torque to both the space vehicle and the platform. As the platform 200 begins moving in response to the torques, vision sensors mounted on the space vehicle monitor the movement of the platform 200. The vision sensors transmit movement measurements to the processing unit 204. The processing unit 204 then adjust the gimbal position in response to the movement measurements from the vision sensors.

In an alternative embodiment, the force indicators 208 may include the object used to apply a torque. For example, when a person uses a wrench to twist a bolt on the outside of the vehicle, the wrench may measure the torque applied to the bolt by the user. When the wrench measures a torque, the wrench is connected to a system that transmits the measurement of the torque to the processing unit 204, wherein the processing unit 204 controls the movement of the gimbals so that the angular momentum of the rotor is opposed to the torque applied to the platform 200, such that the platform remains substantially stable.

In certain embodiments, the size of the platform 200 and the processing parameters are customized according to the requirements of tasks performed by objects attached to the platform. For example, when the task requires large amounts of torque, the platform 200 will be commensurately larger so that the momentum devices 206 within the platform 200 can hold more momentum in order to balance out the torques on the platform 200. Also, the processing parameters change according to the requirements of the task. For example, larger momentum devices 206 are controlled by different parameters as compared to smaller momentum devices 206. Accordingly, a platform 200 may be designed for the accomplishment of a single task or set of tasks.

In a further embodiment, upon startup, the processing unit 204 may initialize the momentum devices 206. When the platform 200 is started, the momentum devices 206 may not have developed sufficient angular momentum to counter torques experienced by the platform 200. In the embodiment where the momentum devices 206 are control moment gyroscopes, the rotors may be spun until the rotors are spinning with the desired angular velocity such that the control moment gyroscopes have sufficient angular momentum to accomplish the desired task. When sufficient angular momentum has developed in the momentum devices 206, the platform 200 is ready to be used as a stable base for the accomplishment of tasks within a low-gravity environment.

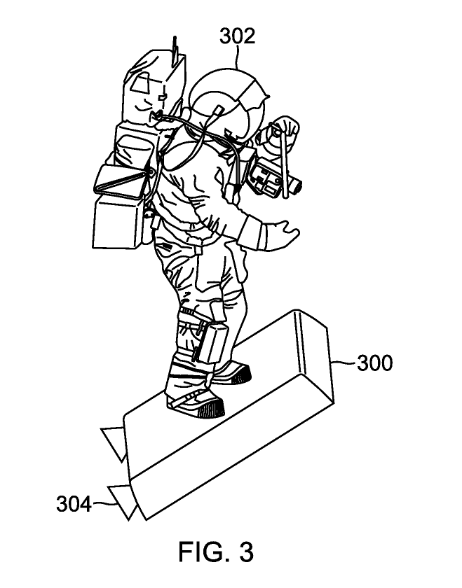

FIG. 3 is an exemplary illustration of an astronaut 302 attached to a platform 300, where the platform 300 is able to provide translational movement. In certain implementations, the platform 300 functions in a similar manner to platform 100 in FIG. 1. While the momentum devices within the platform 300 use the conservation of angular momentum to oppose torques experienced by the platform 300, the momentum devices are unable to provide a force that results in translational movement. In certain embodiments, to provide translational movement for the platform 300, the platform 300 includes one or more translational devices 304 capable of providing a translational force. For example, a translational device 304 may include thrusters or other type of device capable of providing controllable motion from one location to another location. When the astronaut 302 desires to move from one location to another, the astronaut 302, or other platform controller, may provide instructions to the translational device 304 to put forth a force in the desired direction such that the platform moves to the desired location. In at least one implementation, the translational device 304 and the momentum devices within the platform 300 function together to maintain the platform 300 at a fixed location in reference to a particular object in space.

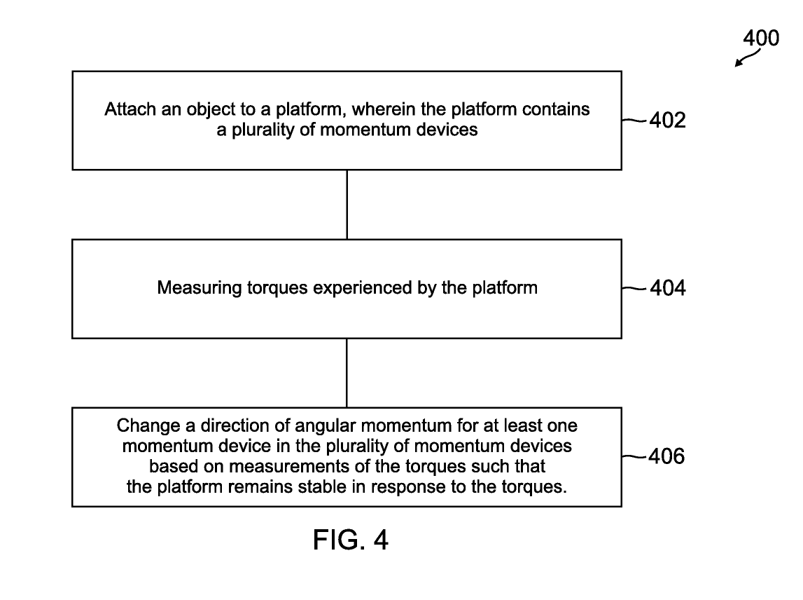

FIG. 4 is a flow diagram of a method 400 for opposing torques in a low gravity environment. In at least one embodiment, method 400 proceeds at 402, where an object is attached to a platform, wherein the platform contains a plurality of momentum devices. For example, a platform may be a transportable object containing multiple control moment gyroscopes. An object, like an astronaut or a robot attaches to the platform. The control moment gyroscopes may be controlled by a processing unit that is able to control the direction of angular momentum for each of the control moment gyroscopes. Method 400 further proceeds at 404 where torques experienced by the platform are measured. For example, when the object attached to the platform exerts a force on a space object like a satellite, or asteroid, the object will frequently exert a torque on the platform. Sensors in the platform or monitoring devices outside the platform, that monitor the movement of the platform, send information about torques to the processing unit. Method 400 proceeds at 406 where a direction of angular momentum for at least one momentum device in the plurality of momentum devices is changed based on measurements of the torques such that the platform remains stable in response to the torques. For instance, the processing unit changes the direction of angular momentum for at least one of the control moment gyroscopes in the plurality of control moment gyroscopes such that the angular momentum of the control moment gyroscopes opposes the torques and the platform provides a stable base for the object to perform a particular task.

### EXAMPLE EMBODIMENTS

Example 1 includes a system for opposing torques, the system comprising: a platform, wherein the platform is transportable to different locations in a zero-gravity environment; a plurality of momentum devices within the platform, wherein the plurality of momentum devices provide controllable angular momentum; a torque feedback device, wherein the torque feedback device detects the torques experienced by the platform; a processing unit that controls the angular momentum of the plurality of momentum devices based on the torques detected by the torque feedback device such that the platform remains stable in response to the torques; and a mounting surface on the platform for attaching objects to the platform.

Example 2 includes the system of Example 1, wherein the plurality of momentum devices comprise at least one of: one or more control moment gyroscopes; or one or more reaction wheels.

Example 3 includes the system of any of Examples 1-2, wherein the torque feedback device comprises an inertial reference system, wherein the inertial reference system is located within the platform.

Example 4 includes the system of any of Examples 1-3, wherein the torque feedback device comprises a movement detection device, wherein the movement detection device externally monitors the location and attitude of the platform to detect platform movement.

Example 5 includes the system of any of Examples 1-4, wherein the torque feedback device comprises a rotation application device, wherein the rotation application device applies a torque to the platform and provides a measurement of the applied force to the processing unit.

Example 6 includes the system of any of Examples 1-5, wherein the object is at least one of: a portion of a spacesuit; or a portion of a robot.

Example 7 includes the system of any of Examples 1-6, further comprising at least one translational device, wherein the translational device provides a force to move the platform through translational motion.

Example 8 includes the system of any of Examples 1-7, wherein the size of the platform is determined by a task performed by the object attached to the platform.

Example 9 includes the system of any of Examples 1-8, wherein the processing unit initializes the plurality of momentum devices such that each momentum device in the plurality of momentum devices has a desired angular momentum.

Example 10. The system of any of Examples 1-8, wherein the processing unit is located within the platform.

Example 11 includes a method for opposing torques, the method comprising: attaching an object to a platform, wherein the platform contains a plurality of momentum devices, wherein each momentum device in the plurality of momentum devices provides controllable angular momentum in a desired direction; measuring torques experienced by the platform; changing a direction of angular momentum for at least one momentum device in the plurality of momentum devices based on measurements of the torques such that the platform remains stable in response to the torques.

Example 12 includes the method of Example 11, wherein the plurality of momentum devices comprise at least one of: one or more control moment gyroscopes; or one or more reaction wheels.

Example 13 includes the method of any of Examples 11-12, wherein the torques are measured by at least one of: an inertial reference system located within the platform; a movement detection device that externally monitors the location and attitude of the platform to detect platform movement; or a rotation application device that applies a torque to the platform and provides a measurement.

Example 14 includes the method of any of Examples 11-13, wherein the object is at least one of: a portion of a spacesuit; or a portion of a robot.

Example 15 includes the method of any of Examples 11-14, further comprising using a translational device to move the platform through translational motion.

Example 16 includes the method of any of Examples 11-15, further comprising determining the size of the platform and control parameters for the plurality of momentum devices based on a task performed by the object attached to the platform.

Example 17 includes the method of any of Examples 11-16, further comprising initializing the plurality of momentum devices such that each momentum device in the plurality of momentum devices has a desired angular momentum.

Example 18 includes a system for providing a stable base in a low-gravity environment, the system comprising: a transportable platform providing a mounting surface, wherein an object can be securely attached to the mounting surface; a plurality of momentum devices within the platform, wherein each momentum device in the plurality of momentum devices is controllable to produce angular momentum a torque feedback device that measures torques experienced by the transportable platform; and a controller that receives measurements of torque from the torque feedback device, wherein the controller controls the direction of angular momentum for each momentum device based on the measurements of rotation force such that the transportable platform remains stable in response to the torques.

Example 19 includes the system of Example 18, wherein the plurality of momentum devices comprise at least one of: a control moment gyroscope; or a reaction wheel.

Example 20. The system of Example 18, wherein the controller comprises: a processing unit located within the platform; or a processing unit located externally to the platform, wherein directions to control the direction of angular momentum are transmitted to the platform.

Although specific embodiments have been illustrated and described herein, it will be appreciated by those of ordinary skill in the art that any arrangement, which is calculated to achieve the same purpose, may be substituted for the specific embodiments shown. Therefore, it is manifestly intended that this invention be limited only by the claims and the equivalents thereof.

What is claimed is:

1. A system for opposing torques, the system comprising:
a platform, wherein the platform is transportable to different locations in a zero-gravity environment;
a plurality of momentum devices within the platform, wherein the plurality of momentum devices provide controllable angular momentum;
a torque feedback device, wherein the torque feedback device detects the torques experienced by the platform;
a processing unit that controls the angular momentum of the plurality of momentum devices based on the torques detected by the torque feedback device such that the platform remains stable in response to the torques; and
a mounting surface on the platform for attaching objects to the platform.

2. The system of claim 1, wherein the plurality of momentum devices comprise at least one of:
one or more control moment gyroscopes; or
one or more reaction wheels.

3. The system of claim 1, wherein the torque feedback device comprises an inertial reference system, wherein the inertial reference system is located within the platform.

4. The system of claim 1, wherein the torque feedback device comprises a movement detection device, wherein the movement detection device externally monitors the location and attitude of the platform to detect platform movement.

5. The system of claim 1, wherein the torque feedback device comprises a rotation application device, wherein the rotation application device applies a torque to the platform and provides a measurement of the applied force to the processing unit.

6. The system of claim 1, wherein the object is at least one of:
a portion of a spacesuit; or
a portion of a robot.

7. The system of claim 1, further comprising at least one translational device, wherein the translational device provides a force to move the platform through translational motion.

8. The system of claim 1, wherein the size of the platform is determined by a task performed by the object attached to the platform.

9. The system of claim 1, wherein the processing unit initializes the plurality of momentum devices such that each momentum device in the plurality of momentum devices has a desired angular momentum.

10. The system of claim 1, wherein the processing unit is located within the platform.

11. A method for opposing torques, the method comprising:
attaching an object to a platform, wherein the platform contains a plurality of momentum devices, wherein each momentum device in the plurality of momentum devices provides controllable angular momentum in a desired direction;
measuring torques experienced by the platform;
changing a direction of angular momentum for at least one momentum device in the plurality of momentum devices based on measurements of the torques such that the platform remains stable in response to the torques.

12. The method of claim 11, wherein the plurality of momentum devices comprise at least one of:
one or more control moment gyroscopes; or
one or more reaction wheels.

13. The method of claim 11, wherein the torques are measured by at least one of:
an inertial reference system located within the platform;
a movement detection device that externally monitors the location and attitude of the platform to detect platform movement; or
a rotation application device that applies a torque to the platform and provides a measurement.

14. The method of claim 11, wherein the object is at least one of:
a portion of a spacesuit; or
a portion of a robot.

15. The method of claim 11, further comprising using a translational device to move the platform through translational motion.

16. The method of claim 11, further comprising determining the size of the platform and control parameters for the plurality of momentum devices based on a task performed by the object attached to the platform.

17. The method of claim 11, further comprising initializing the plurality of momentum devices such that each momentum device in the plurality of momentum devices has a desired angular momentum.

18. A system for providing a stable base in a low-gravity environment, the system comprising:
a transportable platform providing a mounting surface, wherein an object can be securely attached to the mounting surface;
a plurality of momentum devices within the platform, wherein each momentum device in the plurality of momentum devices is controllable to produce angular momentum
a torque feedback device that measures torques experienced by the transportable platform; and
a controller that receives measurements of torque from the torque feedback device, wherein the controller controls the direction of angular momentum for each momentum device based on the measurements of rotation force such that the transportable platform remains stable in response to the torques.

19. The system of claim 18, wherein the plurality of momentum devices comprise at least one of:
a control moment gyroscope; or
a reaction wheel.

20. The system of claim 18, wherein the controller comprises:
a processing unit located within the platform; or
a processing unit located externally to the platform, wherein directions to control the direction of angular momentum are transmitted to the platform.
